(19) United States
(12) Patent Application Publication
(10) Pub. No.: US 2020/0311193 A1
(43) Pub. Date: Oct. 1, 2020

(54) AUGMENTED REALITY NOTE GRID TO SPREADSHEET

(71) Applicant: Konica Minolta Laboratory U.S.A., Inc., San Mateo, CA (US)

(72) Inventor: Paul Bosma, Nederland, CO (US)

(73) Assignee: Konica Minolta Laboratory U.S.A., Inc., San Mateo, CA (US)

(21) Appl. No.: 16/370,469

(22) Filed: Mar. 29, 2019

(51) Int. Cl. G06F 17/24; G06F 3/042; G06K 9/46

(52) U.S. Cl. CPC G06F 17/246; G06K 9/4604; G06F 3/0425

(57) ABSTRACT

A method for processing an augmented reality (AR) workspace includes: projecting a grid comprising a cell onto a surface of the AR workspace; obtaining a first image of the AR workspace that includes the grid and a first content of the grid; extracting the first content from the first image of the AR workspace; and generating an internal representation of the AR workspace that includes the extracted first content.

### BACKGROUND

Augmented Reality (AR) allows a user to interact with a computer-generated AR output overlaid on or around objects in a real-world environment. In some cases, the computer-generated AR output may be projected into the real-world environment such that the user does not have to hold a smartphone or wear AR glasses. Often, the user's experience is improved when the AR system captures the user's intent with minimal or no direct interaction with a computer interface. For example, dynamically tracking and recording a user's organization of ideas has potential to be useful in brainstorming or project organization.

### SUMMARY

In general, one or more embodiments of the invention relate to a method for processing an augmented reality (AR) workspace. The method comprises: projecting a grid comprising a cell onto a surface of the AR workspace; obtaining a first image of the AR workspace that includes the grid and a first content of the grid; extracting the first content from the first image of the AR workspace; and generating an internal representation of the AR workspace that includes the extracted first content.

In general, one or more embodiments of the invention relates to a system for processing an AR workspace. The system comprises: a memory; and a processor coupled to the memory. The processor: projects a grid comprising a cell onto a surface of the AR workspace; obtains a first image of the AR workspace that includes the grid and a first content of the grid; extracts the first content from the first image of the AR workspace; and generates an internal representation of the AR workspace that includes the extracted first content.

In general, one or more embodiments of the invention relates to a non-transitory computer readable medium (CRM) storing computer readable program code for processing an AR workspace. The computer readable program code causes a computer to: project a grid comprising a cell onto a surface of the AR workspace; obtain a first image of the AR workspace that includes the grid and a first content of the grid; extract the first content from the first image of the AR workspace; and generate an internal representation of the AR workspace that includes the extracted first content

Other aspects of the invention will be apparent from the following description and the appended claims.

### BRIEF DESCRIPTION OF DRAWINGS

FIG. 1 shows a system in accordance with one or more embodiments of the invention.

FIG. 2 shows a flowchart in accordance with one or more embodiments of the invention.

FIG. 3 shows a flowchart in accordance with one or more embodiments of the invention.

FIG. 4 shows a flowchart in accordance with one or more embodiments of the invention.

FIGS. 5A-5B shows an implementation example in accordance with one or more embodiments of the invention.

FIGS. 6A-6B shows an implementation example in accordance with one or more embodiments of the invention.

FIGS. 7A-7B shows an implementation example in accordance with one or more embodiments of the invention.

FIG. 8 shows a computing system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third) may be used as an adjective for an element (i.e., any noun in the application). The use of ordinal numbers is not to imply or create a particular ordering of the elements nor to limit any element to being only a single element unless expressly disclosed, such as by the use of the terms “before,” “after,” “single,” and other such terminology. Rather the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “an AR workspace image” may include reference to one or more of such AR workspace images.

Organizing ideas and information is achieved by manipulating objects in a real-world environment. Often, when a user is working on a project (e.g., brainstorming, organizing an oral or visual presentation, and creating a work product), it may be beneficial to layout documents containing individual ideas or pieces of information (i.e., content) on a surface of a workspace (i.e., an AR workspace). By physically manipulating the documents, information can be rapidly or more easily be reorganized to convey a desired message. Further, aligning the documents according to a predetermined pattern (e.g., a projected grid) may improve the organization of the information.

By obtaining a series of images of the workspace before, during, or after a project, one or more embodiments of the invention allow the user to record and understand the flow and organization of ideas at various stages of the project. Further, extracting information (e.g., text and image) from the workspace and creating an editable digital document that represents the state of the workspace allows the user to edit and share the information with a group.

In general, embodiments of the invention provide a method, a non-transitory computer readable medium (CRM), and a system for processing an augmented reality (AR) workspace.

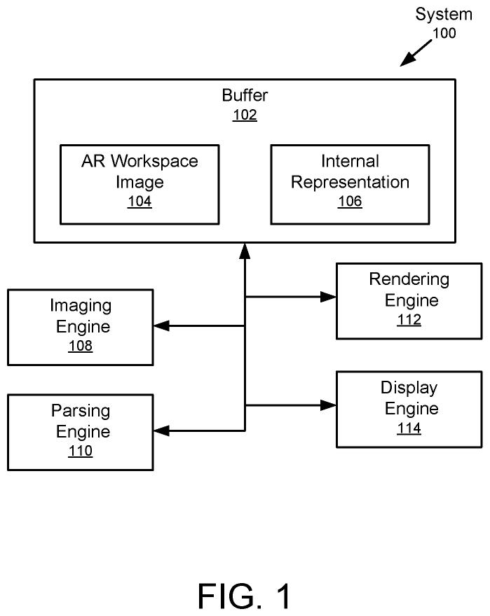

FIG. 1 shows a system in accordance with one or more embodiments of the invention. As shown in FIG. 1, the system (100) has multiple components, and may include, for example, a buffer (102), an imaging engine (108), a parsing engine (110), a rendering engine (112) and a display engine (114). Each of these components (102, 108, 110, 112, and 114) may be located on the same computing device (e.g., a personal computer (PC), laptop, tablet PC, smartphone, multifunction peripheral, kiosk, server, and Projection with Interactive Capture (PIC) device) or on different computing devices connected by a network of any size having wired and/or wireless segments. Each of these components is discussed below.

The buffer (102) may be implemented in hardware (i.e., circuitry), software, or any combination thereof. The buffer (102) is configured to store an AR workspace image (104) and an internal representation (106) of an AR workspace. Multiple AR workspace images (104) or internal representations (106) may be stored in the buffer (102).

The AR workspace image (104) is an image of an AR workspace. The AR workspace may be a surface of any type (e.g., a desk, a wall, a whiteboard, and a floor). Further, the AR workspace may comprise a mat, multiple work surfaces, irregular surfaces, or spatially separated surfaces, but is not particularly limited to these configurations. Accordingly, the AR workspace image (104) may be a single image or multiple images.

In one or more embodiments, the AR workspace comprises an AR note grid (i.e., grid) of one or more cells. The grid may be an AR output image that is projected onto the surface of the AR workspace. The grid may include at least one row and at least one column, but is not particularly limited in dimension, rank, or shape. Each cell of the grid may be delimited by one or more lines (e.g., solid line, dashed line, or dotted line) that defines a cell boundary (e.g. a closed square or rectangular shape). In one or more embodiments, the AR workspace image (104) may comprise one or more cell images that correspond to each cell of the grid.

A cell of the grid may include a document (e.g., a piece of paper, a Post-It (R) note, or any other physical media) containing a content. The content of the document may comprise a text character, a non-text character, a string of text, a drawing, a picture, a chart, an image, a graph, or a table, but is not particularly limited to these examples. The content may be computer-generated, typed, or hand-written, but is not particularly limited to these methods of generation. Accordingly, the AR workspace image (104) includes the grid and the content of any document in the grid.

The AR workspace image (104) may be saved in the buffer (102) in any imaging format (e.g., a JPEG image, a GIF image, a bitmap image, a TIFF image, or a PDF document).

The internal representation (106) may include a stored content. A stored content of the internal representation (106) may include an extracted content of the AR workspace image (104) (e.g., a text character, a non-text character, a string of text, a raster image, a vector image, a graph, or a table), a content of a document (i.e., an electronic copy of the document), a digital document (e.g., a spreadsheet), an AR output image, or a spatial calibration of the AR workspace, but is not particularly limited to these items. In general, the internal representation (106) may comprise information to relate the digital form of the elements listed above to a physical version (e.g., the documents in the AR workspace) or a virtual version (e.g., projected or displayed AR output image) in the real-world environment.

The system (100) includes the imaging engine (108). The imaging engine (108) may be implemented in hardware (i.e., circuitry), software, or any combination thereof. The imaging engine (108) images the AR workspace to generate the AR workspace image (104). Further, the imaging engine (108) may include a 2-dimensional and/or 3-dimensional imager (e.g., a camera or a combination of one or more cameras) that is able to capture a digital image of the AR workspace.

In one or more embodiments, a user may set a timer such that the imaging engine (108) automatically obtains an AR workspace image (104) at periodic intervals. Alternatively, the user may trigger the imaging engine (108) (e.g., by physical control, virtual control, or gesture recognized by the system (100)) to obtain an AR workspace image (1040 when certain conditions of the meeting are met (e.g., the organization of ideas is finalized, or the meeting concludes). However, the methods to control the timing and frequency of obtaining images are not limited to those described herein and that any appropriate method may be used.

The system (100) further includes the parsing engine (110). The parsing engine (110) may be implemented in hardware (i.e., circuitry), software, or any combination thereof. The parsing engine (110) parses the AR workspace image (104) to extract a content that may be subsequently stored in the internal representation (106) of the AR workspace. Further, the parsing engine (110) may segment the AR workspace image (104) into multiple images (e.g., cell images) that may be parsed individually.

The parsing engine (110) may perform an optical character recognition (OCR) or non-text content analysis (e.g., pattern or shape recognition) to identify, format, and extract content (e.g., a text character, a non-text character, a string of text, a grid, a line, a drawing, a picture, a chart, an image, a graph, or a table) within an image (e.g., the AR workspace image (104) or a cell image). Any common or proprietary parsing program (e.g., a word recognition program, a table recognition program, or an image recognition program) that is able to identify and format content within an image may be utilized by the parsing engine (110). The parsing engine (110) may store the extracted content in the buffer (102) to generate or update the internal representation (106) of the AR workspace.

In one or more embodiments, the parsing engine (110) may default to segmenting the AR workspace image (104) into one or more cell images that correspond to each cell of the grid. Further, the parsing engine (110) may associate each cell image with a location in the AR workspace (e.g., anchored to the upper left corner of the corresponding cell in the grid, a relative location within the grid, or an absolute location within the AR workspace) based on the spatial calibration of the AR workspace.

In one or more embodiments, an AR workspace image (104) may contain a document with a content that cannot be extracted. The AR workspace image (104) may comprise a portion of the document, all of the document, or the entire cell containing the document, but is not particularly limited to these examples. If the parsing engine (110) cannot extract a content, the parsing engine (110) may store the AR workspace image (104) in the internal representation (106) of the AR workspace.

In one or more embodiments, the content of the document may comprise an alphanumeric symbol or recognizable shape or pattern. Accordingly, the parsing engine (110) may identify and extract the content using OCR or pattern recognition. The parsing engine (110) may store the extracted content in the internal representation (106) of the AR workspace. Further, the parsing engine (110) may associate the stored content of the internal representation (106) of the AR workspace with the corresponding AR workspace image (104) and/or with a corresponding location in the AR workspace.

In one or more embodiments, a document in the AR workspace may not fit within the grid or a cell of the grid. Further, a document in the AR workspace may not be aligned with the grid (e.g., tilted with respect to the grid or overlaps a boundary of the grid or a cell in the grid). Accordingly, the parsing engine (110) may manipulate an AR workspace image (104) to improve the quality of the extracted content. For example, the parsing engine (110) may: apply a transform (e.g., rotation, scaling, and skew) to the AR workspace image (104); crop the AR workspace image (104); combine multiple AR workspace images (104) that contain the same document. However, the methods of manipulating and parsing an AR workspace image (104) are not limited to those described herein and that any appropriate method may be used.

The system (100) further includes the rendering engine (112). The rendering engine (112) may be implemented in hardware (i.e., circuitry), software, or any combination thereof. The rendering engine (112) renders digital documents and/or AR output images. Any rending program (e.g., a word processing program, or an image processing program) that is able to render the stored content of the internal representation (106) may be utilized by the rendering engine (112).

The rendering engine (112) may render an AR output image comprising the AR note grid that is projected onto the surface of the AR workspace. The rendering engine (112) may include one or more controls (virtual or physical) for a user to manipulate the size, number, position, and/or arrangement of the grid and/or a cell in the grid. In one or more embodiments, the controls may control a size of the grid or a size of a cell in the grid (e.g., a width of the grid and/or a cell in the grid, or a height of the grid and/or a cell in the grid). The controls of the grid are not limited to the examples described herein and that any appropriate controls may be included.

The rendering engine (112) may render a digital document that represents a state of the AR workspace when an AR workspace image (104) was obtained. The digital document may be transferred to a connected computing system or shared with other computing systems for viewing and editing.

The digital document may be rendered using an eXtensible Markup Language (XML) (e.g., Open Office XML (OOXML)). Thus, a rendered content of the digital document may comprise an AR workspace image (104), a cell image, or a rendering of stored content of the internal representation (106) (e.g., a text character, a non-text character, a string of text, a grid, a line, a drawing, a picture, a chart, an image, a graph, or a table). Further, the digital document may be editable by a variety of software platforms that may or may not be supported by the system (100). However, the rendered content of the digital document is not limited to the examples described herein and that the rendered content may include any other appropriate content or information from the AR workspace.

In one or more embodiments, the digital document may be formatted as a spreadsheet. Thus, the rendered content of the digital document may be rendered in one or more cells of the spreadsheet. Further, the rendering engine (112) may render the spreadsheet such that the rendered content has the same spatial organization as the documents in the AR workspace when the AR workspace image (104) was obtained. In other words, the cells of the spreadsheet may correspond to the cells of the grid in the AR workspace.

In one or more embodiments, the digital document may comprise multiple spreadsheets. Each spreadsheet may correspond to a different AR workspace image (104) or different stored content in the internal representation (106) of the AR workspace. By rendering the digital document with a series of spreadsheets that correspond to the AR workspace before, during, and after a project, the digital document allows a user to review and understand the flow and organization of ideas at various stages of the project.

The rendering engine (112) may render an AR output image that represents a state of the AR workspace when an AR workspace image (104) was obtained. Thus, a rendered content of the AR output image may comprise an AR workspace image (104), a cell image, or a rendering of other stored content of the internal representation (106) (e.g., a text character, a non-text character, a string of text, a grid, a line, a drawing, a picture, a chart, an image, a graph, or a table). However, the rendered content of the AR output image is not limited to the examples described herein and that the rendered content may include any other appropriate content or information from the AR workspace.

In one or more embodiments, the rendering engine (112) may render multiple AR output images. Each AR output image may correspond to a different AR workspace image (104) or different stored content in the internal representation (106) of the AR workspace. By rendering, a series of AR output images that correspond to the AR workspace before, during, and after a project, the user can review and understand the flow and organization of ideas at various stages of the project.

The system (100) may include the display engine (114). The display engine (114) may be implemented in hardware (i.e., circuitry), software, or any combination thereof. The display engine (114) may project, using one or more lights, effects, and/or images, a digital document or an AR output image onto a surface of the AR workspace. The display engine (114) may display, using one or more lights, effects, and/or images, a digital document or an AR output image on an output device of the system (100) or a connected computing system.

The display engine (114) may include a 2-dimensional and/or 3-dimensional projector (e.g., a projector or a combination of one or more projectors) that is able to project a digital image onto the AR workspace. The display engine (114) may include a 2-dimensional display (e.g., a liquid crystal display (LCD), a light emitting diode (LED) display, a cathode ray tube (CRT) display, or a thin film transistor (TFT) display), a 3-dimensional display, or a combination of one or more displays that is able to display a digital document or an AR output image. The display engine (114) may operate in an unrestricted color space in visible or non-visible wavelength regimes (e.g., ultraviolet, visible, near infrared, and infrared).

In response to the rendering engine (112) rendering a digital document, the display engine (114) may project or display the digital document. The digital document may be projected within a predetermined region of the AR workspace. The digital document may be displayed within a predetermined region of an output device. The size and shape of the predetermined region of the AR workspace or the predetermined region of the output device may be determined by the display engine (114) or the rendering engine (112).

In response to the rendering engine (112) rendering an AR output image, the display engine (114) may project or display the AR output image. The AR output image may be projected within a predetermined region of the AR workspace. The AR output image may be displayed within a predetermined region of an output device. The size and shape of the predetermined region of the AR workspace or the predetermined region of the output device may be determined by the display engine (114) or the rendering engine (112).

The display engine (114) may project or display a virtual indicator (e.g., status indicator) or virtual control (e.g., button, scroll bar, switch, and knob) that facilitates user interaction with the AR workspace. In a non-limiting example, a virtual control may allow the user to scroll through a series of AR output images or a series of spreadsheets in a digital document. The virtual control may also allow the user to select of one the AR output images or one of the spreadsheets to revert the internal representation (106) of the AR workspace to correspond with the rendered content of the selected spreadsheet or AR output image. In other words, the virtual indicator of virtual control may allow the user to navigate and manipulate the digital document or AR output images.

Although the system (100) is shown as having five components (102, 108, 110, 112, and 114), in other embodiments of the invention, the system (100) may have more or fewer components. Furthermore, the functionality of each component described above may be shared among multiple components. In addition, each component (102, 108, 110, 112, and 114) may be utilized multiple times in serial or parallel to carry out an iterative operation.

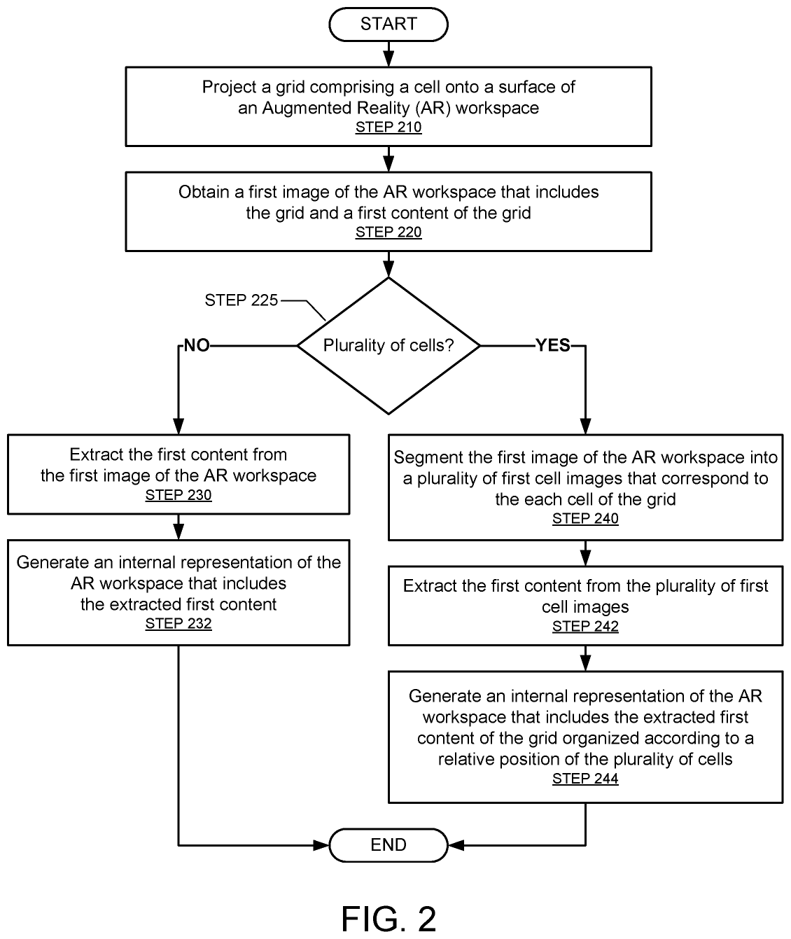

FIG. 2 shows a flowchart for generating an internal representation (106) of an AR workspace in accordance with one or more embodiments of the invention. In a non-limiting example, the user may place documents in the AR workspace and wish to record the AR workspace. Thus, the system (100) will obtain a first AR workspace image (104) and generate an internal representation (106) of the AR workspace.

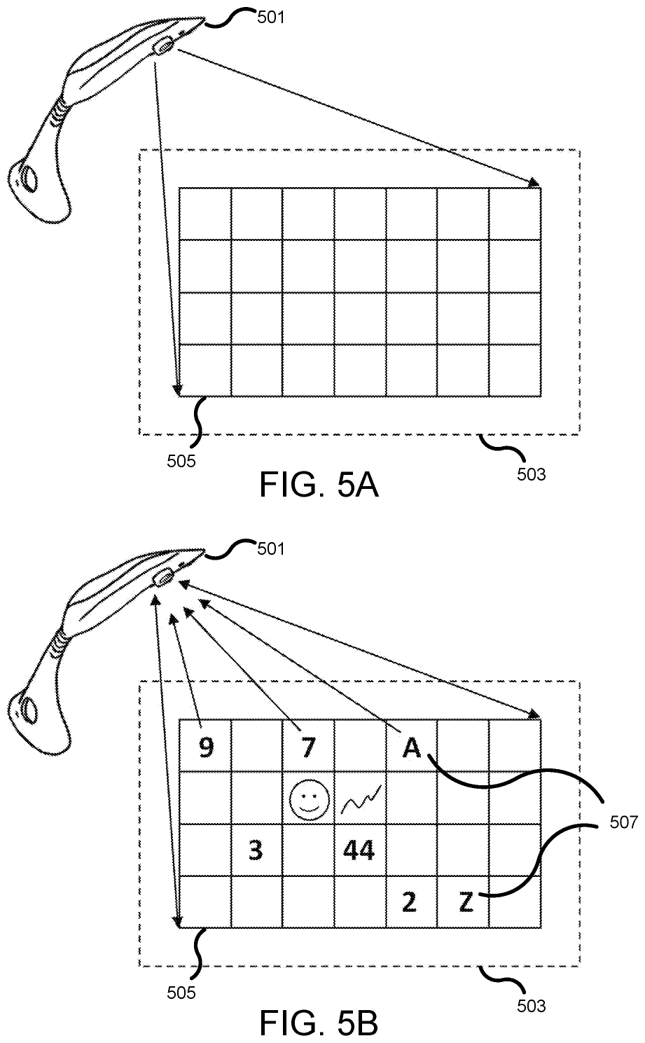

In STEP 210, the system (100) projects an AR output image comprising an AR note grid (i.e., a grid) onto a surface of an AR workspace. The grid may comprise one or more cells arranged in a predetermined pattern (e.g., rows and columns). As discussed above, the AR note grid may be an AR output image generated by the rendering engine (112) and projected by the display engine (114). This process is exemplified in more detailed below, with reference to FIG. 5A.

In STEP 220, a first image of the AR workspace (i.e., an AR workspace image (104)) is obtained. The first image may comprise the grid and a first content of the grid (e.g., a document disposed within the grid or within a cell of the grid). As discussed above, the first image may be obtained by the imaging engine (108). This process is exemplified in more detailed below, with reference to FIG. 5B.

In STEP 225, the system (100) determines whether the grid comprises a plurality of cells.

When the determination in STEP 225 is NO (i.e., the grid contains a single cell), parsing of the first image of the AR workspace proceeds with STEP 230.

In STEP 230, a first content of the AR workspace is extracted from the first image of the AR workspace. As discussed above, the parsing engine (110) may parse the first image to extract the first content (e.g., by identifying and formatting text and non-text content of the document in the first image).

In STEP 232, an internal representation (106) of the AR workspace is generated. As discussed above, the parsing engine (110) may store the extracted first content in the buffer (102) to generate the internal representation (106) of the AR workspace.

When the determination in STEP 225 is YES (i.e., the grid comprises a plurality of cells), parsing of the first image of the AR workspace proceeds with STEP 240.

In STEP 240, the first image of the AR workspace is segmented into a plurality of first cell images that correspond to each cell of the grid in the AR workspace. As discussed above, the parsing engine (110) may segment the first image of the AR workspace into the plurality of first cell images.

In STEP 242, a first content of the AR workspace is extracted from the plurality of first cell images. As discussed above, the parsing engine (110) may individually parse the cell images. Further, the parsing engine (11) may associate each piece of information (e.g., a first cell image, a text object, or a non-text object) in the extracted first content with the corresponding first cell image from which it was extracted.

In STEP 244, an internal representation (106) of the AR workspace is generated to include the extracted first content, organized according to a relative position of the plurality of cells. As discussed above, the parsing engine (110) may store the extracted first content in the buffer (102) to generate the internal representation (106) of the AR workspace. Thus, the stored content of the internal representation (106) of the AR workspace reflects the state of the AR workspace when the first image was obtained.

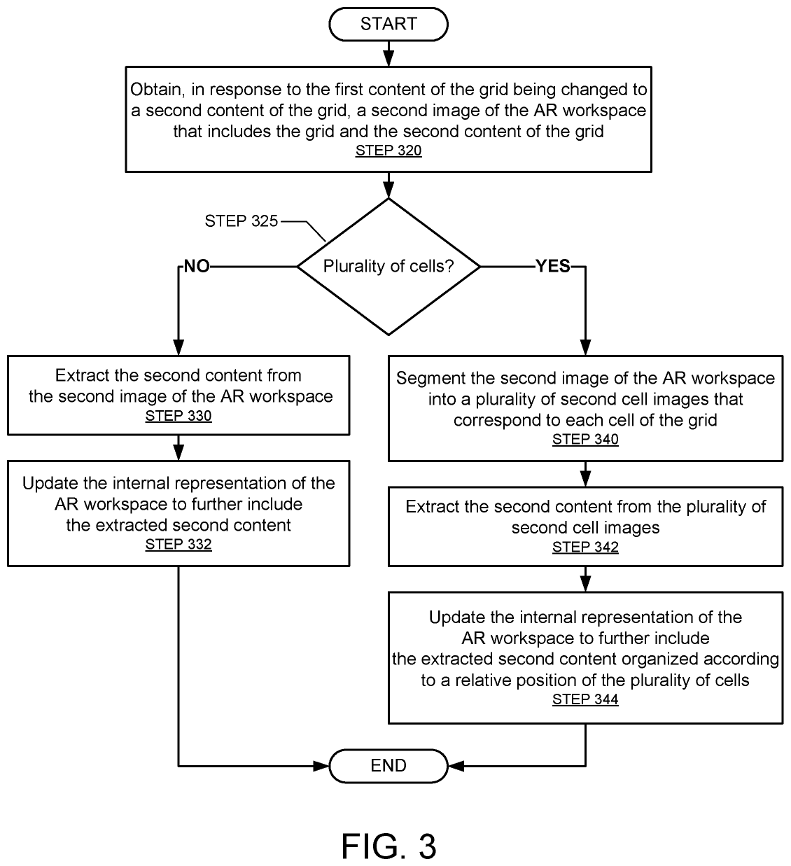

FIG. 3 shows a flowchart for updating the internal representation (106) of the AR workspace in accordance with one or more embodiments of the invention. In a non-limiting example, the user may manipulate documents in the AR workspace and wish to record the updated AR workspace. Thus, the system (100) will obtain a second AR workspace image (104) and update the internal representation (106) of the AR workspace.

In STEP 320, in response to the first content of the grid being changed to a second content of the grid, a second image of the AR workspace is obtained. The second image may comprise the grid and the second content of the grid. The second content of the grid may: include an additional document added to first content of the grid; lack a document that was removed from the first content of the grid; be a rearrangement of the first content of the grid (i.e., no addition or subtraction of content); include an annotation or revision to a document of the first content; be the first content of the grid at a later point in time (e.g., no substantive changes or organization of information has been finalized). The change between the first and second content of the grid is not limited to the examples described herein and that any appropriate change of information in the AR workspace, in time or space, may apply.

In STEP 325, the system (100) determines whether the grid comprises a plurality of cells.

When the determination in STEP 325 is NO (i.e., the grid contains a single cell), parsing of the second image of the AR workspace proceeds with STEP 330.

In STEP 330, a second content of the AR workspace is extracted from the second image of the AR workspace. As discussed above, the parsing engine (110) may parse the second image to extract the second content.

In STEP 332, an internal representation (106) of the AR workspace is updated to further include the extracted second content. As discussed above, the parsing engine (110) may store the extracted second content in the buffer (102) to update the internal representation (106) of the AR workspace.

When the determination in STEP 325 is YES (i.e., the grid comprises a plurality of cells), parsing of the first image of the AR workspace proceeds with STEP 340.

In STEP 340, the second image of the AR workspace is segmented into a plurality of second cell images. As discussed above, the parsing engine (110) may segment the second image of the AR workspace into multiple second cell images. The second cell images may correspond to each cell of the grid in the AR workspace. The second cell images may correspond to the first cell images (i.e., the first and second images of the AR workspace are segmented in the same manner). However, in one or more embodiments, the second image of the AR workspace may be segmented in a different manner than the first image (e.g., the size or shape of the grid is changed, or a different combination of cells are segmented).

In STEP 342, a second content of the AR workspace is extracted from the plurality of second cell images. As discussed above, the parsing engine (11) may associate each piece of information (e.g., a second cell image, a text object, or a non-text object) in the extracted second content with the corresponding second cell image from which it was extracted.

In STEP 344, the internal representation (106) of the AR workspace is updated with the extracted second context. As discussed above, the parsing engine (110) may store the extracted second content in the buffer (102) to update the internal representation (106) of the AR workspace. Thus, the stored content of the internal representation (106) of the AR workspace reflects the state of the AR workspace when the first and second images were obtained.

In one or more embodiments, when the plurality of second cell images correspond to the plurality of first cell images, the stored content of the internal representation (106) of the AR workspace may be updated on a cell-by-cell basis. For example, if no difference is detected between a pair of corresponding first and second cell images, the stored information of the internal representation (106) of the AR workspace may not be updated to conserve system resources (e.g., processing time or memory).

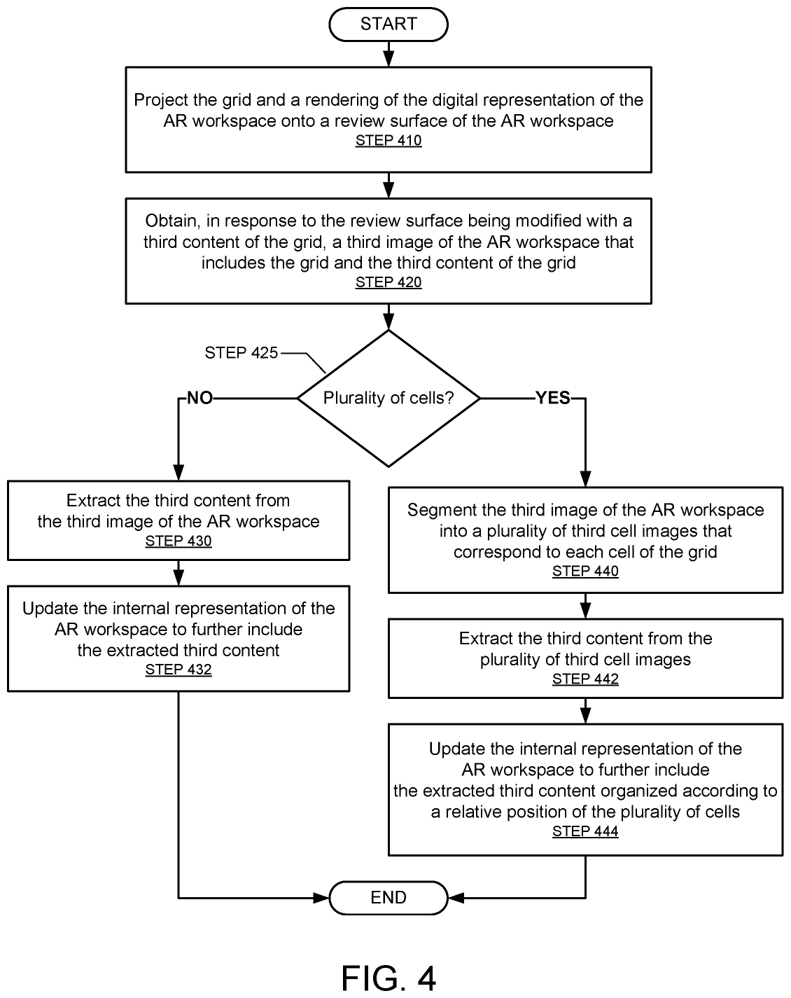

FIG. 4 shows a flowchart for projecting an AR output image, that represents a state of the AR workspace when an AR workspace image (104) was obtained, in accordance with one or more embodiments of the invention. In a non-limiting example, the user may not have access to the original documents used during a previous work session in the AR workspace. Thus, the system (100) will project an AR output image that represents a previous state of the AR workspace when a previous AR workspace image (104) was obtained for the user to continue working on the project.

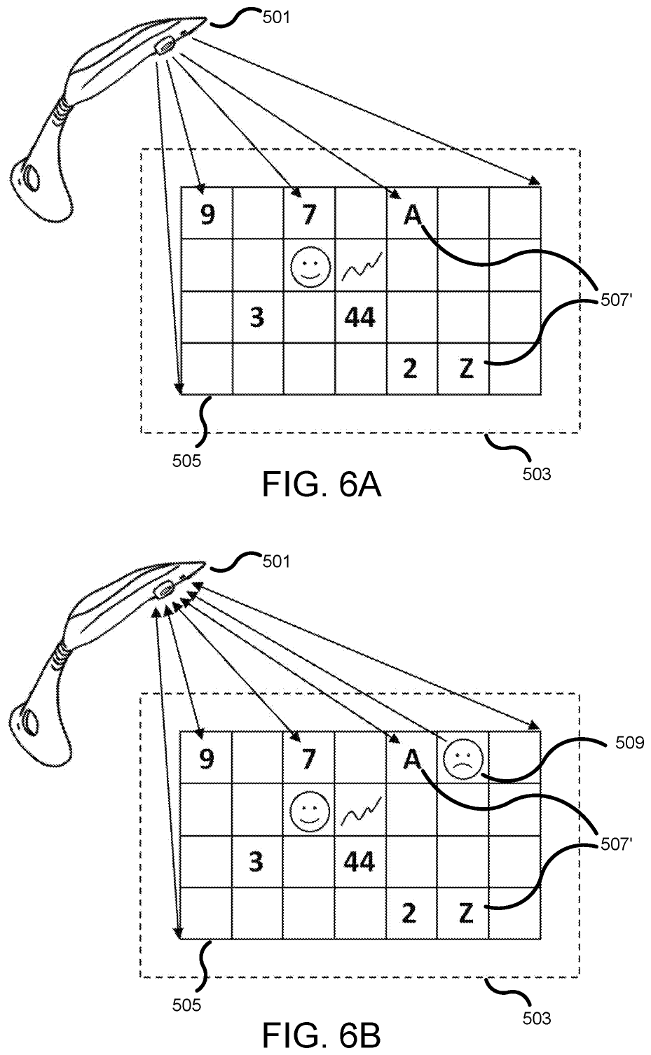

In STEP 410, the system (100) projects an AR output image, that represents a state of the AR workspace when an AR workspace image (104) was obtained, onto a surface of an AR workspace. This process is exemplified in more detailed below, with reference to FIG. 6A. As discussed above, the AR output image generated by the rendering engine (112) and projected by the display engine (114) may represent a previous state of the AR workspace.

In STEP 420, in response to the surface being modified by third content of the grid, a third image of the AR workspace is obtained by the imaging engine (108). This process is exemplified in more detailed below, with reference to FIG. 6B. As discussed above, the third image of the AR workspace may be obtained by the imaging engine (108).

The surface may be modified by a user placing a document in the AR workspace; a user annotating the surface of the AR workspace; a user updating the stored content of the internal representation (106) and projecting a new AR output image; time progressing (i.e., the content of the AR workspace may not substantively change if the user finalizes the organization of information). The change to the surface of the AR workspace is not limited to the examples described herein and that any change of information on the review surface of the AR workspace, in time or space, may apply.

In STEP 425, the system (100) determines whether the grid comprises a plurality of cells.

When the determination in STEP 425 is NO (i.e., the grid contains a single cell), parsing of the third image of the AR workspace proceeds with STEP 430.

In STEP 430, a third content of the AR workspace is extracted from the third image of the AR workspace. As discussed above, the parsing engine (110) may parse the third image to extract the third content.

In STEP 432, an internal representation (106) of the AR workspace is updated to further include the extracted third content. As discussed above, the parsing engine (110) may store the extracted third content in the buffer (102) to update the internal representation (106) of the AR workspace.

When the determination in STEP 425 is YES (i.e., the grid comprises a plurality of cells), parsing of the third image of the AR workspace proceeds with STEP 440.

In STEP 440, the third image of the AR workspace is segmented into a plurality of third cell images. As discussed above, the parsing engine (110) may segment the third image of the AR workspace into the plurality of third cell images. The plurality of third cell images may correspond to each cell of the grid in the AR workspace. The plurality of third cell images may correspond to the first or second plurality of cell images (i.e., the plurality of first, second, and/or third images of the AR workspace are segmented in the same manner). However, in one or more embodiments, the third image of the AR workspace may be segmented in a different manner than the first or second image (e.g., the grid is reduced or increased by a row or column, or different combinations of cells are split).

In STEP 442, a third content of the AR workspace is extracted from the plurality of third cell images. As discussed above, the parsing engine (11) may associate each piece of information (e.g., a third cell image, a text object, or a non-text object) in the extracted third content with the corresponding third cell image from which it was extracted.

In STEP 444, the internal representation (106) of the AR workspace is updated with the extracted third context. As discussed above, the parsing engine (110) may store the extracted third content in the buffer (102) to update the internal representation (106) of the AR workspace. Thus, the stored content of the internal representation (106) of the AR workspace reflects the state of the AR workspace when the first and/or second, and third AR workspace images (104) were obtained.

In one or more embodiments, when the third cell images correspond to the first and/or second cell images, the internal representation may be updated on a cell-by-cell basis. For example, if no difference is detected between a pair of corresponding cell images, the internal representation (106) may not be updated to conserve system resources.

FIGS. 5A-5B show an implementation example of a system (100) generating an internal representation (106) of an AR workspace in accordance with one or more embodiments of the invention.

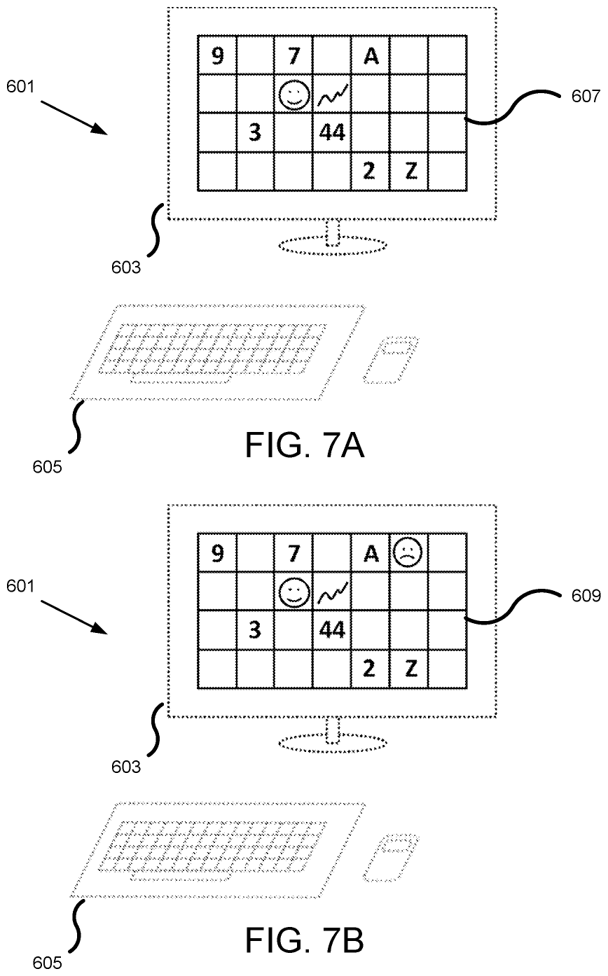

FIG. 5A shows a system (100) that includes a Projection with Interactive Capture (PIC) device (501) that comprises an imager that obtains images of the AR workspace (503) and a projector that projects AR output images onto a surface of the AR workspace (503). The imaging engine (108) includes the imager of the PIC device (501). The display engine (114) includes the projector of the PIC device (501). The display engine (114) may further include a display or output device of a connected computing system (shown in FIGS. 7A-7B).

The PIC device (501) may further comprise a mat (not shown) that functions as the surface of the AR workspace (503). The mat may have a matte surface to minimize reflections/glare and improve the quality (e.g., contrast and brightness) of an AR workspace image (104) obtained by the PIC device (501). The mat may be plastic, vinyl, or any appropriate material for a work surface. However, the PIC device (501) may not include a mat and may use any surface as the AR workspace (503).

The PIC device (501) projects an AR output image comprising the AR note grid (505) onto the surface of the AR workspace (503), as shown by the arrows emitted from the PIC device (501). In the non-limiting examples shown in FIGS. 5A-5B, 6A-6B, and 7A-7B, the default dimensions of the grid are 21 inches in width and 12 inches in height. The default dimensions of the cells within the grid are 3 inches in width and 3 inches in height. Thus, the default grid is defined by square cells arranged with a rank of 4 in a vertical direction and a rank of 7 in a horizontal direction for a total of 28 square cells.

In one or more embodiments, the maximum dimensions of the grid may be 23 inches in width and 14 inches in height. However, the dimensions of the grid (maximum, minimum, or otherwise) are not limited to the examples described herein and that any appropriate dimensions may be used.

In one or more embodiments, the maximum dimensions of a cell in the grid may be 23 inches in width and 14 inches in height (i.e., resulting in only one cell that matches the maximum dimensions of the grid). In one or more embodiments, the minimum dimensions of a cell in the grid may be 1 inch in width and 1 inch in height. Further, when the grid comprises more than one cell, the cells may or may not have a single consistent size. The dimensions of a cell in the grid (maximum, minimum, or otherwise) are not limited to the examples described herein and that any appropriate dimensions may be used.

FIG. 5B shows a PIC device (501) obtaining an AR workspace image (104) after the AR workspace (503) has been populated with a first content may include various documents (507) (e.g., a drawing on a piece of paper or a Post-It (R) note) disposed in several cells of the grid (505). The PIC device (501) images the grid (505) and the first content of the AR workspace (503), as shown by the arrows entering the PIC device (501). As discussed above, the parsing engine (110) and rendering engine (112) of the system (100) process the obtained AR workspace image (104) to generate the internal representation (106) of the AR workspace (503).

FIG. 6A-6B show an implementation example of a system (100) projecting an AR output image, that represents a state of the AR workspace when an AR workspace image (104) was obtained, and updating the internal representation (106) of the AR workspace in accordance with one or more embodiments of the invention.

FIG. 6A shows the PIC device (501) projecting an AR output image comprising the AR note grid (505) and a rendering (507′) of stored content of the internal representation (106) onto the surface of the AR workspace (503), as shown by the arrows emitted from the PIC device (501). Thus, the AR workspace (503) shows a state of the AR workspace when an previous AR workspace image (104) was obtained.

FIG. 6B shows a PIC device (501) obtaining an AR workspace image (104) of the grid (505) after the surface of the AR workspace has been modified with a third content (509) (e.g., a new document was placed in a cell or a user drew an image on the surface of the AR workspace (503)). The PIC device (501) images the grid (505) and the third content of the AR workspace (503), as shown by the arrows entering the PIC device (501). As discussed above, the parsing engine (110) and rendering engine (112) of the system (100) process the obtained AR workspace image (104) and update the internal representation (106) of the AR workspace (503).

FIG. 7A-7B show an implementation example of a connected computing system (601) displaying a digital document comprising multiple spreadsheets that correspond to the AR workspace (503) in accordance with one or more embodiments of the invention. The connected computing system (601) includes a 2-dimensional display (603) and an input device (605) and may be connected by a network (not shown) of any size, having wired and/or wireless segments, to the PIC device (501) shown in FIGS. 5A-5B and 6A-6B.

In FIG. 7A, the connected computing system (601) displays a first spreadsheet (607) of the digital document on the display (603). The first spreadsheet comprises a rendering of stored content of the internal representation (106) that corresponds to the state of the AR workspace (503) shown in FIG. 6A.

In FIG. 7B, the connected computing system (601) displays a second spreadsheet (609) of the digital document on the display (603). The second spreadsheet comprises a rendering of stored content of the internal representation (106) that corresponds to the state of the AR workspace (503) shown in FIG. 6B.

As discussed above, in one or more embodiments, the user may switch between the two spreadsheets to review and understand the flow and organization of ideas in the AR workspace (503). Further, the user may interact with the connected computing system (601) to update and edit the internal representation (106) of the AR workspace (503).

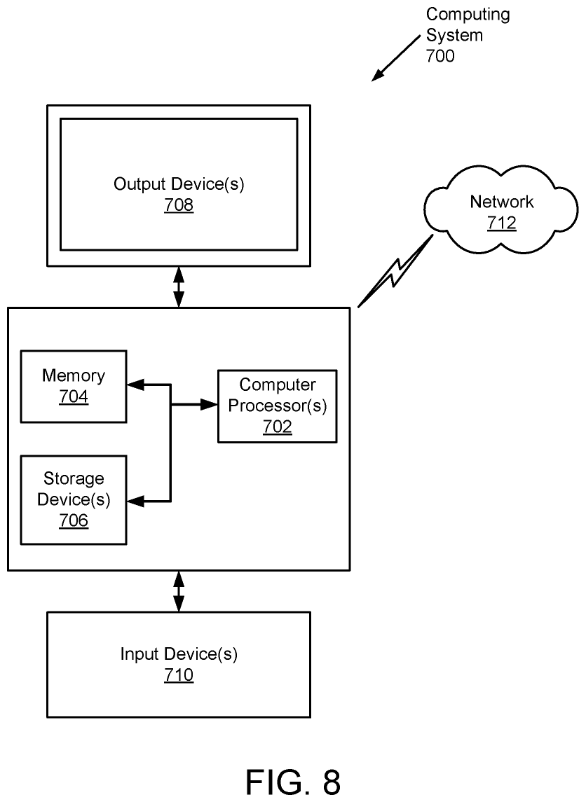

Embodiments of the invention may be implemented on virtually any type of computing system, regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments of the invention. For example, as shown in FIG. 8 the computing system (700) may include one or more computer processor(s) (702), associated memory (704) (e.g., random access memory (RAM), cache memory, flash memory), one or more storage device(s) (706) (e.g., a hard disk, an optical drive such as a compact disk (CD) drive or digital versatile disk (DVD) drive, a flash memory stick), and numerous other elements and functionalities. The computer processor(s) (702) may be an integrated circuit for processing instructions. For example, the computer processor(s) may be one or more cores, or micro-cores of a processor. The computing system (700) may also include one or more input device(s) (710), such as a camera, imager, touchscreen, keyboard, mouse, microphone, touchpad, electronic pen, or any other type of input device. Further, the computing system (700) may include one or more output device(s) (708), such as a projector, screen (e.g., a liquid crystal display (LCD), a plasma display, touchscreen, cathode ray tube (CRT) monitor, or other display device), a printer, external storage, or any other output device. One or more of the output device(s) may be the same or different from the input device(s). The computing system (700) may be connected to a network (712) (e.g., a local area network (LAN), a wide area network (WAN) such as the Internet, mobile network, or any other type of network) via a network interface connection (not shown). The input and output device(s) may be locally or remotely (e.g., via the network (712)) connected to the computer processor(s) (702), memory (704), and storage device(s) (706). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

Further, one or more elements of the aforementioned computing system (700) may be located at a remote location and be connected to the other elements over a network (712). Further, one or more embodiments of the invention may be implemented on a distributed system having a plurality of nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

One or more of the embodiments of the invention may have one or more of the following advantages: the ability to record and create an editable digital representation of an AR workspace at various stages of a project without multiple applications running (e.g., capture software, Microsoft Excel (R)); the ability to project an AR output image, that represents a state of the AR workspace when an AR workspace image was obtained, such that a user may work on a project without the original documents of a project; the ability to facilitate spontaneous meetings without the original documents of a project; the ability to manipulate the organization of project information in a real-world environment (i.e., without a separate computing system) or a digital document that can be shared without a separate application (e.g., Microsoft Excel (R)); the ability to review the organization of project information in a real-world environment or a digital document that can be shared.

Although the disclosure has been described with respect to a limited number of embodiments, those skilled in the art, having benefit of this disclosure, will appreciate that various other embodiments may be devised without departing from the scope of the present invention. Accordingly, the scope of the invention should be limited only by the attached claims.

1. A method for processing an augmented reality (AR) workspace, the method comprising:
projecting a grid comprising a cell onto a surface of the AR workspace with a projector;
obtaining a first image of the AR workspace that includes the grid and a first content of the grid with an imager;
extracting the first content from the first image of the AR workspace; and
generating an internal representation of the AR workspace that includes the extracted first content.

2. The method of claim 1, further comprising:
obtaining, in response to the first content of the grid being changed to a second content of the grid, a second image of the AR workspace that includes the grid and the second content of the grid,
extracting the second content from the second image of the AR workspace, and
updating the internal representation of the AR workspace to further include the extracted second content.

3. The method of claim 1, wherein when the grid includes a plurality of cells,
extracting the first content from the first image of the AR workspace comprises:
segmenting the first image of the AR workspace into a plurality of first cell images that correspond to each cell of the grid; and
extracting the first content from the plurality of first cell images, and
the extracted first content included in the internal representation of the AR workspace is organized according to a relative position of the plurality of cells.

4. The method of claim 3, further comprising:
obtaining, in response to the first content of the grid being changed to a second content of the grid, a second image of the AR workspace that includes the grid and the second content of the grid;
segmenting the second image of the AR workspace into a plurality of second cell images that correspond to each cell of the grid;
extracting the second content from the plurality of second cell images, and
updating the internal representation of the AR workspace to further include the extracted second content, organized according to a relative position of the plurality of cells.

5. The method of claim 1, further comprising:
projecting, onto the surface of the AR workspace, an AR output image including the grid and rendering of a stored content of the internal representation of the AR workspace;
obtaining, in response to the review surface being modified with a third content of the grid, a third image of the AR workspace that includes the grid and the third content of the grid;
extracting the third content from the third image of the AR workspace, and
updating the internal representation of the AR workspace to further include the extracted third content, organized according to a relative position of the plurality of cells.

6. The method of claim 1, wherein the internal representation of the AR workspace includes a digital spreadsheet document.

7. The method of claim 6, wherein the digital spreadsheet document is generated with an eXtensible Markup Language (XML).

8. The method of claim 2, further comprising:
displaying a digital spreadsheet document, including the extracted first content and the extracted second content, on an output device of a connected computing system.

9. The method of claim 2, further comprising:
projecting a series of AR output images, including the extracted first content and extracted second content, onto a review surface of the AR workspace.

10. The method of claim 1, wherein the first image of the AR workspace is obtained using a Projection with Interactive Capture (PIC) device that comprises the imager and the projector.

11. A system for processing an augmented reality (AR) workspace, the system comprising:
a memory; and
a processor coupled to the memory, wherein the processor:
projects a grid comprising a cell onto a surface of the AR workspace with a projector;
obtains a first image of the AR workspace that includes the grid and a first content of the grid with an imager;
extracts the first content from the first image of the AR workspace; and
generates an internal representation of the AR workspace that includes the extracted first content.

12. The system of claim 11, wherein the processor further:
obtains, in response to the first content of the grid being changed to a second content of the grid, a second image of the AR workspace that includes the grid and the second content of the grid,
extracts the second content from the second image of the AR workspace, and
updates the internal representation of the AR workspace to further include the extracted second content.

13. The system of claim 11, wherein when the grid includes a plurality of cells,
the processor extracts the first content from the first image of the AR workspace by:
segmenting the first image of the AR workspace into a plurality of first cell images that correspond to each cell of the grid; and
extracting the first content from the plurality of first cell images, and
the extracted first content included in the internal representation of the AR workspace is organized according to a relative position of the plurality of cells.

14. The system of claim 13, wherein the processor further:
obtains, in response to the first content of the grid being changed to a second content of the grid, a second image of the AR workspace that includes the grid and the second content of the grid;
segments the second image of the AR workspace into a plurality of second cell images that correspond to each cell of the grid;
extracts the second content from the plurality of second cell images, and
updates the internal representation of the AR workspace to further include the extracted second content, organized according to a relative position of the plurality of cells.

15. The system of claim 11, wherein
the grid is projected onto the surface of the AR workspace using a Projection with Interactive Capture (PIC) device that comprises the projector and the imager,
the PIC device is controlled by the processor, and
the first image of the AR workspace is obtained by the imager.

16. A non-transitory computer readable medium (CRM) storing computer readable program code for processing an augmented reality (AR) workspace, the computer readable program code causes a computer to:
project a grid comprising a cell onto a surface of the AR workspace with a projector;
obtain a first image of the AR workspace that includes the grid and a first content of the grid with an imager;
extract the first content from the first image of the AR workspace; and
generate an internal representation of the AR workspace that includes the extracted first content.

17. The CRM of claim 16, wherein the computer readable program code further causes a computer to:
obtain, in response to the first content of the grid being changed to a second content of the grid, a second image of the AR workspace that includes the grid and the second content of the grid,
extract the second content from the second image of the AR workspace, and
update the internal representation of the AR workspace to further include the extracted second content.

18. The CRM of claim 16, wherein when the grid includes a plurality of cells,
the computer readable program code further causes a computer to extract the first content from the first image of the AR workspace by:
segmenting the first image of the AR workspace into a plurality of first cell images that correspond to each cell of the grid; and
extracting the first content from the plurality of first cell images, and
the extracted first content included in the internal representation of the AR workspace is organized according to a relative position of the plurality of cells.

19. The CRM of claim 18, wherein the computer readable program code further causes a computer to:
obtain, in response to the first content of the grid being changed to a second content of the grid, a second image of the AR workspace that includes the grid and the second content of the grid;
segment the second image of the AR workspace into a plurality of second cell images that correspond to each cell of the grid;
extract the second content from the plurality of second cell images, and
update the internal representation of the AR workspace to further include the extracted second content, organized according to a relative position of the plurality of cells.

20. The CRM of claim 16, wherein
the grid is projected onto the surface of the AR workspace using a Projection with Interactive Capture (PIC) device that comprises the projector and the imager,
the computer readable program code controls the PIC device, and
the first image of the AR workspace is obtained by the imager.
